(19) United States
(12) Patent Application Publication
(10) Pub. No.: US 2007/0104025 A1
(43) Pub. Date: May 10, 2007

(54) Bottom soil improving apparatus utilizing characteristics of solar battery, DC motor and expanded paddle vanes

(75) Inventor: Hiroya Inaba, Yokohama-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SENSOR LABO.CORP., Yokohama-city (JP)

(21) Appl. No.: 11/270,465

(22) Filed: Nov. 10, 2005

(51) Int. Cl. B01F 7/22

(52) U.S. Cl. 366/270

(57) ABSTRACT

A system which turns at a low speed paddle vanes expanded in the direction toward the water surface can cultivate a vast volume of water with a very little quantity of energy and expose water at the water bed to the sun and winds. This enables flows generated near the water surface to expand indefinitely along the water surface exactly as the law of conservation of angular motion predicts, and there are generated flows converging on the original starting point of the flows. These cyclic flows activate the water bed and enables fishes to increase, and food chain serves to purity the water. This is a simple system of merely cultivating water with sunlight, needing no advanced technology, extra energy or chemicals. The present invention is intended to provide a bottom soil improving apparatus which draws on natural purifying forces and activates a vast stretch of water.

### BACKGROUND OF THE INVENTION

This invention relates to a bottom soil improving apparatus for supplying oxygen and thereby facilitating recovery of the ecosystem in the water bed of ponds, dammed lakes or sea inlets where the bottom has run into anaerobic conditions, water has become rotten and fishes are prevented from growing, and enabling food chain to purify water while helping the proliferation of fishes.

Regarding the purification of water in large ponds, dammed lakes or sea inlets, various systems were devised and put into use previously. Yet, none of them proved successful. Recently, however, a method of cultivating water with vanes broadly expanded toward the water surface and purifying water by utilizing natural forces (see Japanese Patent No. 3360075) has come to be extensively used, attracting note from interested quarters, and good results have been reported.

It needs neither advanced technology nor chemicals. If a solar battery is built into this system which can activate and revive a water area of as large as 3000 m² with electric power of only 50 watts, no external power source will be required, and all difficult problems in aqueous environment including the purification of water and the culture of fishes will be solved solely with solar energy. It will also open a new field of application for solar batteries, accelerate the spread of solar battery use, which should make important contributions to the conservation of the global environment by reducing CO₂ emissions and otherwise. From this point of view, experiments to purify ponds by turning paddle vanes with solar battery power have come to be undertaken in many different places.

### SUMMARY OF THE INVENTION

However, this is not so simple a problem that can be solved by merely replacing an AC power supply with a solar battery as the source of turning force. Since the weather is highly variable from fine to cloudy or rainy, the driving conditions for the motor might wildly fluctuate. In order to enable them to keep on turning even when cloudy or rainy and whether in the morning or in the evening, a storage battery should be charged with the current generated by the solar battery to keep the driving conditions constant. However, this storage battery has its own service life. It is heavy, and its regular maintenance is troublesome.

There also is the fear of contamination with lead used in the storage battery. It would be questionable to use in an apparatus which is supposed to purify the environment with a heavy metal which might contaminate the environment. This argument which looks ahead to the future of environmental issues cannot be ignored.

What poses the biggest problem in the use of a solar battery is the storage battery. The object of the present invention is to provide a bottom soil improving apparatus capable of continuously cultivating pond water even on cloudy days and rainy days, for many hours from sunrise to sunset, irrespective of the relative intensity of sunlight, supplying oxygen to the water bed and preventing the water bed from becoming rotten.

### BRIEF DESCRIPTION OF THE DRAWINGS

FIG. 1 shows an embodiment of the present invention in which the characteristics of a solar battery, a DC motor and paddle vanes expanded in the direction toward the water surface are coordinated.

FIG. 2 is a block diagram showing drive control in a case in which a brushless DC motor or a stepping motor using no brush is employed.

### DETAILED DESCRIPTION OF THE INVENTION

Experiments were conducted to find out whether or not a pond could be prevented from becoming rotten by charging a storage battery with the current generated by a solar battery, converting it into an AC and turning paddle vanes expanded in the direction toward the water surface with an AC motor. The duration of driving was eight hours a day, from eight o'clock in the morning till four o'clock in the afternoon. As a result, confidence was gained that, if a DC motor was used and the revolving speed of the vanes was automatically varied with the relative intensity of sunlight, the pond could be well prevented from becoming rotten even without using a storage battery.

When the paddle vanes expanded in the direction toward the water surface are turned at low speed, water at the bottom comes up guided toward the water surface, and flows following the law of conservation of angular motion are generated on the water surface. The water having come up to the water surface, riding on the flows and exposed to winds and the sun, expand indefinitely along the water surface. In that process, winds blowing over the water surface cause water to let off ammonia and odor which are harmful to fishes, and the sunlight stimulates photosynthesis by phytoplanktons to produce oxygen. Flows of water increased in dissolved oxygen content and cleared of harmful contents return to the water bed, and converge on the original starting point of the flows while creeping over the bottom and supplying oxygen to the water bed to activate the water bed to turn it into a farm producing planktons. Water-soluble nitrogen and phosphorus are fixed to the planktons in this farm and provide feeds to insects, small fish and small shrimps in the water, and they in turn feed eel, sea bream, globefish and so forth; this food chain converts them into fishes and thereby causes them to disappear. Organic substances contained in sludge provide another valuable organic resource. They serve as fertilizers for the farm of activated water bed, are turned into planktons and then into fishes, and eventually disappear.

This system which cultivates water and purifies water to help recover the ecosystem purifies ponds, dammed lakes and sea inlets by drawing on the purifying forces of nature, namely three forces including those of the sun, winds and protein production by the water bed farm, and can be regarded as embodying a principle of drawing on the self-cleaning force of nature to purify water. Judging from what was stated above, the purifying force based on this principle will be zero if the area of the water surface is zero, and will also be zero if the quantity of cultivated water is zero. Therefore, the cleaning force working on this principle can be represented by the product of multiplying the area of the water surface by the cultivated water quantity, and regarded as being proportional to the cultivated water quantity.

According to the theory of flow, this cultivated water quantity Q [m³/s] can be expressed in the following way by using the length R [m] from the rotation shaft to the tip of each paddle vane and the number of revolutions of the vanes f [rps]:
Q=K₁R³f (1)
where K₁ is a shape factor determined by the shape of the paddle vanes.

On the other hand, the current generated by the solar battery is proportional to the intensity of the sunlight, and the torque of the DC motor is proportional to the current flowing in the driving coil. Therefore, where the torque obtained by directly supplying the generated current to the coil of the DC motor and thereby turning the motor is amplified with a reduction gear to turn the vanes, the number of revolutions of the vanes of the vanes can be expressed in the following way in terms of the sunlight intensity I [W]:
f=K₂(ηk/ρσR⁵)^{1/2}(I)^{1/2} (2)
where η is the transmission efficiency of the reduction gear; ρ[Kg/m³] is the density of water; σ is the reduction ratio of the reduction gear; and k[s] is a proportional constant representing the proportional relationship between the torque and the light intensity. K₂ is another shape factor determined by the shape of the paddle vanes.

Substitution of Equation (2) into Equation (1) to express the cultivated water quantity by introducing anew the shape factor K gives:
Q=K(ηk/ρσ)^{1/2}(RI)^{1/2} (3)
It is thus seen that the water quantity cultivated with the solar battery and the DC motor is proportional to the ½-th power of the length R of the paddle vanes and the light intensity I.

According to this, even if the light intensity on a cloudy day falls to ½ of that on a fine day, the cultivated water quantity will decrease only by 30%. Even if it further weakens to 1/9, the cultivated water quantity will decrease to only ⅓ of that on a fine day. The calculation reveals that, even when I is small on account of a low intensity of light, a sufficient cultivated water quantity can be obtained by expanding the paddle vanes to increase R.

However, a problem with a DC motor is the service life of the brush which comes into contact with a rotating commutator to supply a current. It is at most 2000 hours, which means only 200 days if it is driven 10 hours a day. Since the system requires installation at the center of a large pond, it would be a heavy workload on the maintenance personnel who would have to row a boat to reach the apparatus.

In such a case, the system can be made maintenance-free by using a brushless DC motor or a stepping motor each consisting of a driving circuit and a driving coil but using no brush. By directly supplying the current generated by the solar battery to the driving coil and so controlling the number of revolutions of the motor with a driving circuit that the vanes turn at a number of revolutions expressed by Equation (2) cited above, namely a number of revolutions proportional to the ½-th power of the light intensity, the revolutions of the paddle vanes will be automatically controlled in accordance with the relative intensity of sunlight and the cultivated water quantity will vary with the ½-th power of the sunlight intensity as expressed by Equation (3) cited above, with the result that the impact of sunlight fluctuations is alleviated.

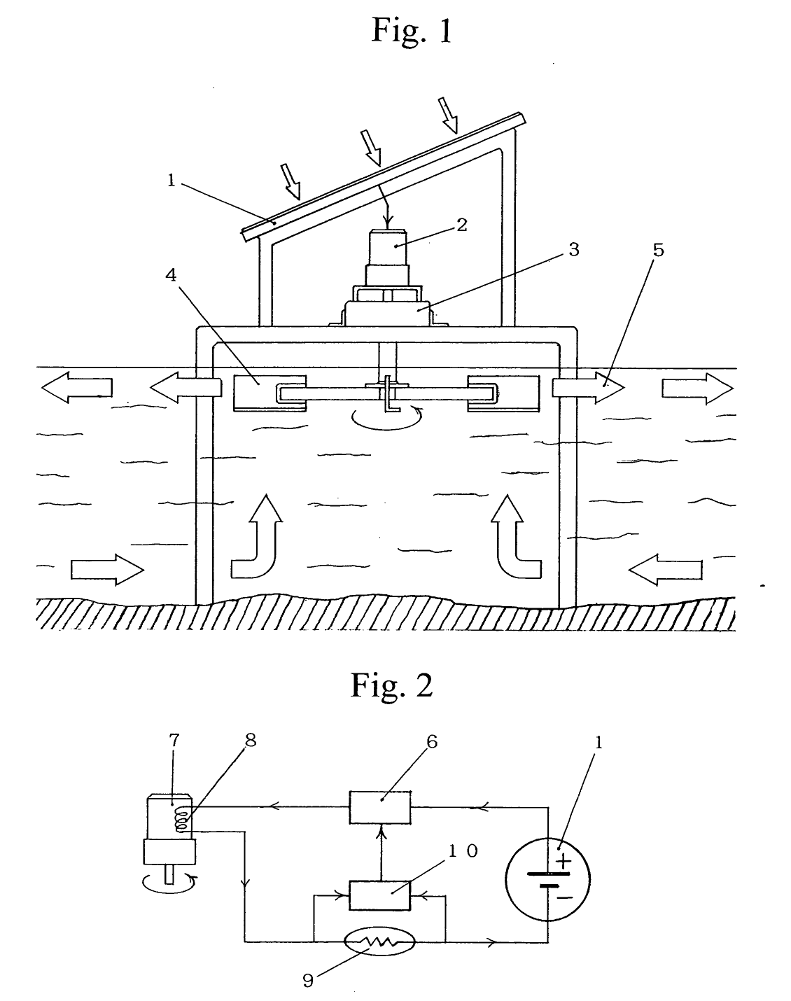

FIG. 1 shows an embodiment of the present invention in which the characteristics of a solar battery, a DC motor and paddle vanes expanded in the direction toward the water surface are coordinated; it is a bottom soil improving apparatus enabled to prevent the water bed from becoming anaerobic with solar energy alone. An electric current generated by a solar battery (1) is directly supplied to a DC motor (2) to turn the DC motor with a torque proportional to the intensity of sunlight. The motor torque is amplified with a reduction gear (3), and paddle vanes (4) expanded in the direction toward the water surface are turned to create flows expanding in the direction toward the water surface. This causes water at the water bed to come up guided toward the water surface and to expand in the direction toward the water surface to create circulatory flows in the directions of flow arrows (5). The mechanism is such that these flows cause water rich in dissolved oxygen content near the water surface to return to the water bed and creep over the water bed to supply oxygen to the water bed.

FIG. 2 is a block diagram showing drive control in a case in which a brushless DC motor or a stepping motor using no brush is employed. The current generated by the solar battery (1) is directly supplied to the driving coil (8) of a brushless DC motor (7) through an inverter (6). A micro-resistor (9) inserted into this driving coil circuit in series is intended for measuring the amperage of the current flowing in the current. A driving circuit (10), supplied with a voltage emerging at the two ends of this resistor, so controls the inverter that the number of revolutions of the motor be proportional to the amperage, namely to the ½-th power of the sunlight intensity. The mechanism is such that automatic control of the number of revolutions to satisfy the condition of Equation (2) described above provides a cultivated water quantity varying according to the ½-th power of the sunlight intensity as represented by Equation (3) cited above.

The efficiency of the conventional system in which a storage battery is charged with the current generated by a solar battery is converted into a 100 V AC and vanes are turned with an AC motor is as low as 50% or even less. However, the system according to the invention directly linking a solar battery and a DC motor can achieve an efficiency of 75% or even more. Therefore, it is calculated that the generation capacity, namely the area, of the solar battery can be reduced to 70% or even less of the area required by the prior art.

A usual fluid machine, such as a water wheel or a pump, which is driven by a motor indispensably requires a storage battery. Such a machine can continue to exert its due performance capability and endure use without a storage battery for only four hours or so. Whereas the sunlight intensity on a very fine day is 1[SUN] (1000 W/m²), the machine is unusable on a cloudy day on which the intensity drops to ½ [SUN]. According to the present invention, however, even when the light intensity drops to 1/9 [SUN], only the cultivated water quantity drops to ⅓, but the apparatus does not become unusable.

The months from March to September constitute a period in which the water bed is apt to become anaerobic. As the system according to the invention, however, keeps on cultivating water for about 10 hours from sunrise to sunset and supplying oxygen to the water bed, no rotting occurs on the water bed. Further, the operating duration is shortened to about eight hours during the shorter sunshine months of November to February. In this period, however, as the water bed requires less oxygen because the water temperature is lower, six-hour operation is sufficient. Here is made available a maintenance-free purification system that can, irrespective of the relative length of sunshine duration, cultivate water all the year around from morning till night according to the weather and season, prevent rotting on the water bed, help fishes grow and purify water.

By combining paddle vanes expanded to a length of 1 m from the rotation axis to their respective tips with a solar battery of 0.25 m² in square measure and a brushless DC motor, a culture pond of 1500 m² in area and 1.5 m in water depth can be prevented from becoming rotten. Realization of culture not dependent on chemicals, such as antibiotics or formalin, namely natural culture, will be no mere dream.

As is evident from the foregoing description, the present invention requires no storage battery. Therefore, it is free from maintenance worries. Where such a system is to be installed in a large pond, dammed lake or sea inlet measuring several kilometers, there could be a problem of power supply, but this system is free from such worries. Wherever there is water, it can be installed, and there will be an infinite demand for it. It is not just a matter of aqueous environment. A water bed cultivated and activated is a farm that can produce planktons (protein). The productivity of such a farm is claimed to be 200 times as high as that of a conventional farm where soil is cultivated and soybeans are planted for the production of protein. It can be expected to make great contributions to solving the food problem of the humankind on the earth and the problem of the global environment by reducing CO₂ emissions. It requires nothing more than sunlight. It needs neither advanced technology nor chemicals. The invention provides an unprecedented bottom soil improving apparatus which cultivates water according to the time schedule of nature, draws upon natural purifying forces, activates the water bottom, helps fishes grow and thereby purifies water.

1. A bottom soil improving apparatus so disposed as to supply oxygen to the water bed by turning paddle vanes, broadly expanded in the direction toward the water surface, with the torque of a DC motor obtained through direct connection to a solar battery and amplified by a reduction gear for the purpose of cultivating water with weak light and making the quantity of water thereby cultivated less susceptible to the relative intensity of sunlight.

2. The bottom soil improving apparatus, as set forth in claim 1, wherein a brushless DC motor or a stepping motor of a type which uses no rectifier or brush but is turned by a driving circuit and a driving coil is employed, the current generated by the solar battery is directly supplied to the driving coil of the motor, and the speed of revolution is controlled by the driving circuit according to the relative intensity of light.
